(19) United States
(12) Patent Application Publication
(10) Pub. No.: US 2005/0254935 A1
(43) Pub. Date: Nov. 17, 2005

(54) Bucket attachment for loader

(76) Inventor: Bruce Downing, Plano, TX (US)

Correspondence Address: Steven Thrasher, 391 Sandhill Dr., Richardson, TX, 75080, US

(21) Appl. No.: 11/187,135

(22) Filed: Jul. 22, 2005

Related U.S. Application Data
(63) Continuation of application No. 10/642,411, filed on Aug. 15, 2003, now abandoned.

(51) Int. Cl. B66F 9/00

(52) U.S. Cl. 414/723

(57) ABSTRACT

The invention provides a loader attachment for a loader. The loader attachment allows for the handling and placing of a flowable material therefrom. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### RELATED APPLICATION

The invention is a continuation in part of, is related to and claims priority from co-pending U.S. patent application Ser. No. 10/642,411 entitled BUCKET ATTACHMENT FOR LOADER by Bruce Downing, filed on 24 Jul. 2003.

### TECHNICAL FIELD

The invention relates generally to loaders, and more specifically the invention relates to loader attachments.

### STATEMENT OF A PROBLEM ADDRESSED BY THE INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Loaders, such as the BOBCAT® 763 skid-steer loader are well known in the construction and earth excavation industries. Loaders also include wheel steer loaders, track loaders, compact track loaders, and skid-steer loaders, for example. Construction and earth excavation professionals like steer skid loaders because they offer a low-maintenance and low-cost way to quickly and powerfully perform projects which are not large enough to warrant the use of larger, more expensive construction equipment.

One distinguishing feature of smaller loaders is that they have systems that are used to couple attachments to the loader. For example, some loaders use skids (the parallel “fingers” on the front portion of a loader). Skids are often seen in warehouse settings sliding underneath a pallet so that the pallet may be lifted and moved. Skids may operate in horizontal or vertical configurations depending on the type of loader and its use. Other loaders use other coupling means, such as the Bobcat® quick-connect system.

In the earth construction and excavation industries there exists many loader attachments. These attachments allow the loader to accomplish a specific application(s). One such attachment is a digging bucket that handles dirt and other earthen materials. There are many application specific buckets, such as low profile buckets, light material buckets, fertilizer buckets, and construction-industrial buckets. However, there exist needs for additional bucket attachments to offer loader operators more control in various loader operations. The present invention provides multiple embodiments of an inventive bucket attachment.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings.

FIG. 1 is a block diagram of an inventive loader attachment for a loader.

FIG. 2 illustrates a loader attachment with an inventive pourer portion.

FIG. 3 provides a top-down view of the loader attachment.

FIG. 4 illustrates yet a further embodiment of a bucket attachment for a Bobcat®.

FIG. 5 shows a top-down view of yet a further embodiment of the bucket attachment of FIG. 4.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Of course, the foregoing discussions and definitions are provided for clarification purposes and are not limiting. Words and phrases are to be given their ordinary plain meaning unless indicated otherwise.

Discussion of the Drawings

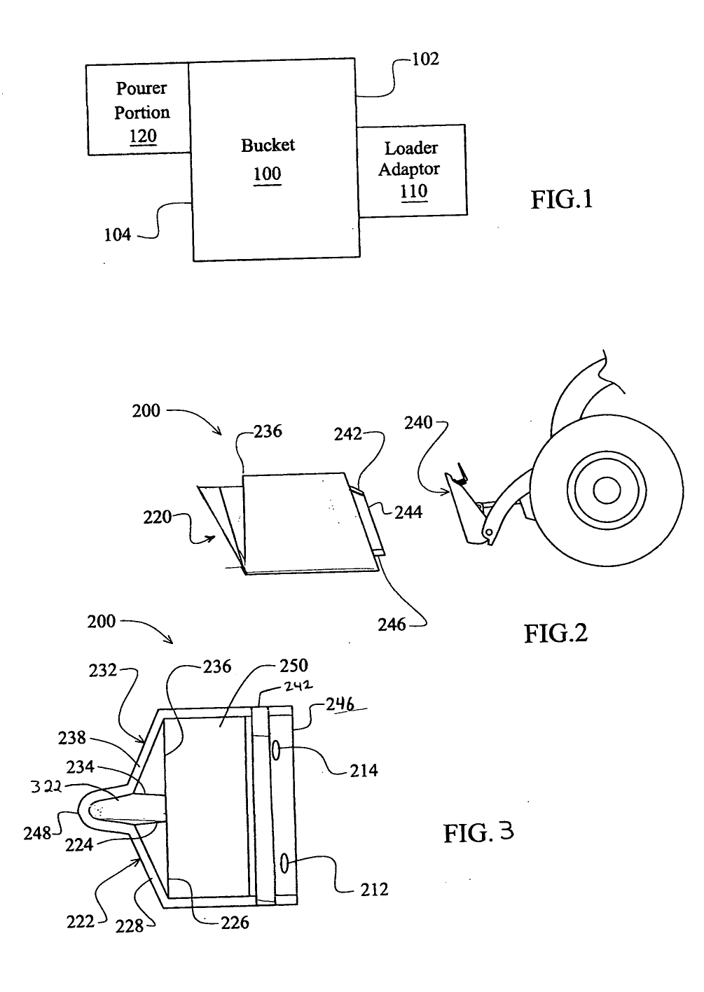

The features and advantages of the invention can be better understood by reviewing FIG. 1, which is a block diagram of an inventive loader attachment for a loader. The attachment generally includes a pourer portion 120, a bucket 100 and a loader adapter 110 that attaches to a loader. The pourer portion 120 is any device or system that provides directional control for pouring a flowable material, such as a liquid, small stones, sand, and similar materials, for example, from the bucket 100. In one embodiment, the pourer is separate from the lip and extending from the lip, and coupled to the front of the bucket at the top of the bucket.

The loader adapter 110 is generally similar to existing loader adapters, and thus the adapter 110 may utilize any existing systems, devices, or methods of adaptation for allowing a bucket attachment to couple to the skids of a loader, such as a Bobcat® quick-connect, or skids, for example. Accordingly, the invention can be characterized as a loader attachment for a loader that attaches to a Bobcat® loader, such that the attachment controls the pouring of a flowable material from a bucket. Of course, many other adaptors are known and readily apparent to those of ordinary skill in the art, and such attachments known or unknown, foreseeable and unforeseeable are incorporated within the claims.

In general, the bucket is defined as having a rear portion, which is the portion of the bucket closest to a loader where the attachment is attached to the loader, and a front, which is defined as the portion of the bucket opposite the rear. The bucket may also have a first side that couples the front to the rear portion, a second side that also couples the front to the rear portion and is opposite the first side. Additionally, although generally straight sides, front, and rear are shown in the figures, the invention is not so limited. Curved and angled sides, front and rear are also incorporated within the scope of the invention.

FIG. 2 illustrates one embodiment of a loader attachment with an inventive pourer portion 220, while FIG. 3 provides a top-down view of the loader attachment 200. In FIG. 2 one may see that the loader attachment 200 couples to a loader 240 having a quick-attach system such as that available from the Bobcat® Company. The loader attachment 200 couples to the loader quick attach system via a lip 242, a first brace 244 (and second brace 245, in FIG. 3), and a lock rib 246. The lip 242 extends at least three inches from and horizontally across the rear portion of the bucket. The lip 242 may be continuous across the rear portion, at least the horizontal length of the quick attach system of the loader 240 as is known in the art, or may comprise a number of extensions intermittently spaced across the length of the quick attach system of the loader 240. The brace first brace 244 and second brace 245 provide rigid structural support to the lip 242 and the lock rib 246.

Likewise, the lock-rib 246 extends horizontally across the rear portion of the bucket at least the length of the quick attach system of the loader 240 as is known in the art. Preferably, the lock-rib 246 comprises lock handles. Thus, from FIG. 3, it is seen that the loader attachment 200 comprises a first latch handle 212 and a second latch handle 214 which are preferably embodied as holes that are substantially vertical, and substantially parallel, such that the latch handles 212, 214 may accept quick-connect latches (or handles) from the quick attach system of the loader 240, as is known in the art.

Of course, any of the existing systems or methods of coupling a loader attachment to a loader a readily adaptable to the present invention, and are incorporated herein, and are known in the art. In addition, it is understood that some embodiments of loader attachments have substantially horizontal channels for accepting skids or other supports, and such channels may be utilized in the present invention without departing from the scope or spirit of the invention. Additionally, the adapter 110 may comprise a plurality of loops, or a plurality of brackets, or a combination of loops and brackets, which are adapted to couple to a loader attachment means, such as a skid or Bobcat® quick-connect. The loops and brackets are then preferably coupled to the rear portion of the bucket.

Continuing with the discussion of FIG. 3, it can be seen that the pourer portion 220 may include a first triangular section 222 having a first edge 224 and a second edge 226 and a top lip 228 and a second triangular section 232 having a first edge 234 a second edge 236 and a top lip 238. A lip of the bucket may be defined generally as comprising the top lip 228 of the first triangular section 222 and the top lip 238 the second triangular section 223.

Here, the first edge 224 of the first triangular section 222 are separated by an optional pourer 248. The pourer 248 of the present embodiment is coupled to the first edge 234 of the second triangular section 232, and the second edge 226 of the first triangular section 222. Although the pourer 248 may comprise straight and planar surfaces, the present pourer comprises a generally cylindrical shaft extending from the lip of the pourer portion 220 to a front-bottom portion of the bucket 250. In the present embodiment, the shaft comprises a channel 322. Because the channel 322 preferably extends to a lower portion of the front of the bucket, substantially all of any flowable material may be poured from the bucket and out of the pourer portion 220. Accordingly, the channel 322 is preferably solid-form to allow a liquid to flow between the bucket 250 and the pourer portion 220. Accordingly, in the present embodiment, the pourer 248 extends away from the lip(s) 228, 238, while the top lip of the pourer may in combination with the lips 228, 238 may form a pourer portion lip.

As is seen in FIG. 3 preferably, the bucket and pourer are integral, meaning that they form a single continuous housing. However, it should be understood that the pourer may comprise a first triangular section and a second triangular section, which are welded or otherwise coupled (including removably coupled) to the bucket 250 as separate items, or other pourer shapes that are readily understood by those of ordinary skill in the art upon reading the present disclosure.

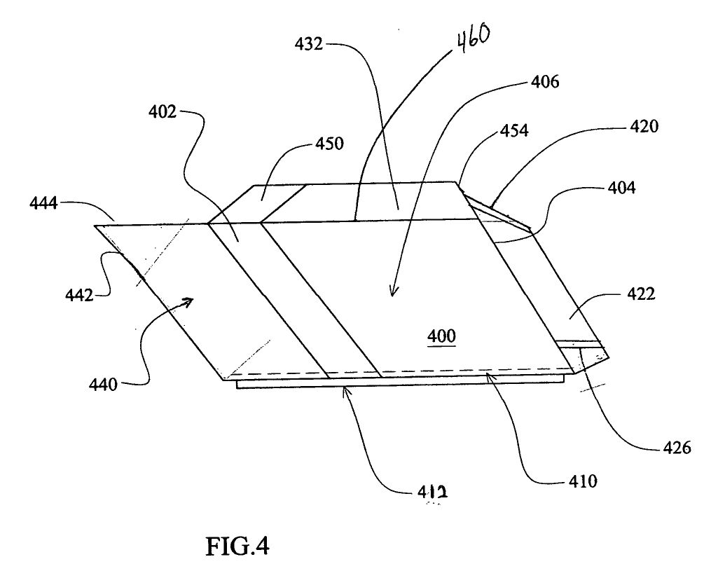

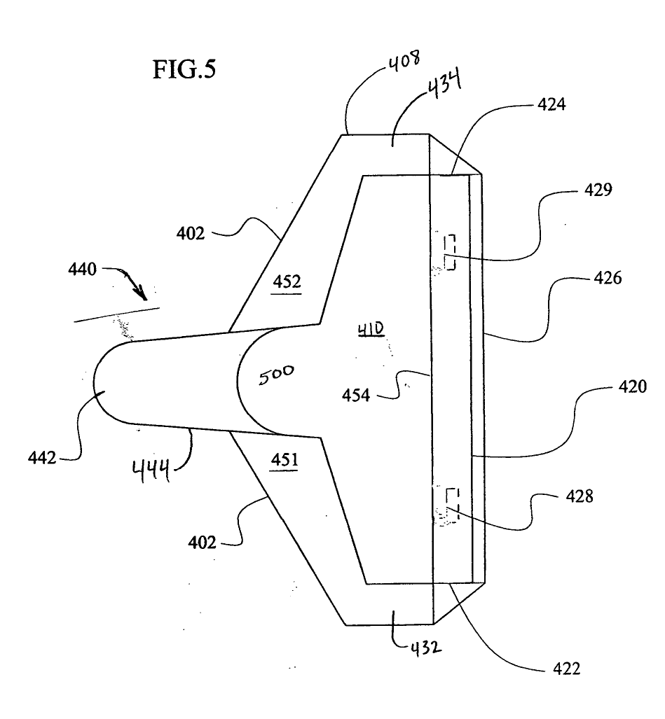

FIGS. 4 and 5 together illustrate an alternative embodiment of a bucket attachment for a Bobcat® (the bucket 400). The bucket 400 comprises a generally solid form front 402, and solid form back 404, first side 406, second side 408 (shown in FIG. 5), and bottom floor 410. The floor 410 may be reinforced with braces 412 arranged along the floor 410 in any manner readily apparent to those of ordinary skill in the art, including manners unknown, foreseeable, and unforeseeable. Of course, the braces provide reinforcement to the floor, and any equivalent structures for reinforcement are incorporated within the scope of the claims, such as a thickened floor.

The rear 404 includes the means for attaching the bucket 400 to a loader—in this embodiment a Bobcat® loader having a Bobcat® quick-attach system, which is known in the art and has been described in detail, above, and generally includes a horizontal catch lip 420 proximate to the top of the bucket 400, a vertical first brace 422 proximate to the first side 406, a vertical second brace 424 proximate to the second side 408, and a horizontal rail 426 proximate to the bottom 410 of the bucket having latching holes 428, 429 therethrough.

At the front 402 of the bucket is a pourer portion 440 and comprises a spout 442 and an open spout lip 444 that is positioned lower than splash guards 450. The pourer portion 440 may be attached to or integrally formed with the bucket 400. In addition, the bucket 400 has at least one via 500 extending through the front 402 of the bucket and into the pourer portion 440 so that liquid may flow between the bucket 400 and the pourer portion 440 and pour out of the lip 444. Accordingly, the via 500 is definable as a hole in the front of the bucket 400 through which a flowable material may move from the bucket 400 and into the pourer portion 440.

A splashguard 450 comprises a first front splashguard 451, a second front splashguard 452, a first side splashguard 432, a second side splashguard 434, and a rear splashguard 454. In one embodiment, the splashguard 450 extends about the top of the bucket 400 at each of its sides and the back of the bucket. Preferably, the splashguard 450 is about three or more inches high, and extends inward, over an open portion of the bucket. Of course, a splashguard is preferably implemented as a simple solid planar structure, but other splashguards and equivalents are readily apparent to those of ordinary skill in the art upon reading this disclosure. In addition, the splashguard 450 is either attached to or is integrally formed with the top of the bucket 400, and in the present embodiment extends at least three inches above the top 460 of the bucket 400. Further, the splashguard 450 is preferably angled to extend over the otherwise open top 460 of the bucket 400. Thus, in use, the splash guard 450 prevents fluid and liquid contents inside of the bucket 400 from splashing, sloshing, or otherwise leaving the bucket, except through the via 500 and pourer portion 440.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

Further, other features and embodiments of the invention will be apparent to those of ordinary skill in the art. After reading this specification, including the Exemplary Embodiment, these persons will recognize that similar results can be achieved in not dissimilar ways. Accordingly, the Exemplary Embodiment is provided as an example of the best mode of the invention, and it should be understood that the invention is not limited by it, but, rather, the invention should be read as being limited only by the claims.

1. A loader attachment for a loader, the attachment for controlling the pouring of a flowable material from the bucket, comprising:
a bucket configured for attachment to a loader, the bucket having a front and a rear, the front having a via;
the bucket adapted to contain a flowable material;
a pourer portion coupled to the front of the bucket and about the via, the pourer portion separate from the lip and extending from the lip; and
a loader adaptor configured at the rear of the bucket, the loader adapter having a generally horizontal catch lip attached to the rear of the bucket, and a generally horizontal rail attached to the rear of the bucket, the rail having a first and second locking hole therethrough.

2. The attachment of claim 1 further comprising a channel disposed between the front of the bucket and the pourer portion.

3. The attachment of claim 2 wherein the channel is further disposed in a lower portion of the front of the bucket, and wherein said channel is adapted to allow a liquid flow between the bucket and the pourer portion.

4. The attachment of claim 2 wherein the channel shape is matched to the pourer portion shape.

5. The attachment of claim 1 wherein the loader adaptor comprises a first quick connect channel and a second quick connect channel.

6. The attachment of claim 5 wherein the quick connect channels are substantially horizontal.

7. The attachment of claim 1 wherein the loader adapter comprises a skid adapter having skid channels that are substantially vertical.

8. The attachment of claim 1 wherein the pourer portion comprises a conical section, the conical section being coupled to the bucket at the cut of the conical section.

9. The attachment of claim 1 wherein the loader adaptor is coupled to the back of the bucket.

10. The attachment of claim 9 wherein the loader adaptor comprises a plurality of loops, each loop being adapted to mounting system.

11. The attachment of claim 3 wherein the bucket and pourer are integral.

12. The attachment of claim 11 wherein the bucket and pourer are formed of a single-piece construction comprising a fiberglass material.

13. The attachment of claim 11 wherein the bucket and pourer are formed of a single-piece construction comprising a plastic material.

14. The attachment of claim 11 wherein the bucket and pourer are formed of a single-piece construction comprising a metal material.

15. The attachment of claim 1 wherein the pourer portion comprises:
a first triangular section having a first edge, a second edge and a top;
a second triangular section having a first edge, a second edge and a top;
the first edge of the first triangular section being coupled to the first edge of the second triangular section; and
the second edge of the first triangular section being coupled to the bucket, and the second edge of the second triangular section being coupled to the bucket.

16. The attachment of claim 15 wherein the bucket and pourer portion are integral.

17. The attachment of claim 1 wherein the skid adaptor system has a first brace and a second brace, each of the first brace and the second brace is adapted to receive a skid.
